(19) United States
(12) Patent Application Publication
(10) Pub. No.: US 2019/0030853 A1
(43) Pub. Date: Jan. 31, 2019

(54) LAMINATE COMPOSED OF A FIRST LAYER MADE OF A FIRST MATERIAL, AND OF A SECOND LAYER MADE OF A POLYMER REINFORCED WITH CONTINUOUS-FILAMENT FIBERS

(71) Applicant: BASF SE, Ludwigshafen am Rhein (DE)

(72) Inventors: Reinhard JAKOBI, Ludwigshafen (DE); Andrea NIXDORF, Ludwigshafen (DE); Linus Niklas LOEHNER, Ludwigshafen (DE)

(73) Assignee: BASF SE, Ludwigshafen am Rhein (DE)

(21) Appl. No.: 16/071,661

(22) PCT Filed: Jan. 18, 2017
(86) PCT No.: PCT/EP2017/050955

§ 371 Date: Jul. 20, 2018

(30) Foreign Application Priority Data
Jan. 22, 2016 (EP) 16152394.9

(51) Int. Cl. B32B 5/02; B32B 15/14

(52) U.S. Cl. CPC B32B 5/02; B32B 2260/046; B32B 2260/021; B32B 15/14

(57) ABSTRACT

The invention relates to a laminate composed of a first layer made of a first material, and of a second layer made of a polymer reinforced with continuous-filament fibers, where the first layer and the second layer have been bonded over a substantial surface area to one another, where the continuous-filament fibers in the second layer have been oriented in at least three fiber directions, where the three fiber directions lie within a plane oriented parallel to the first layer, and the fiber content has been adjusted in such a way that the coefficient of thermal expansion of the second layer in essence corresponds to the coefficient of thermal expansion of the first layer.

The invention is based on a laminate composed of a first layer made of a first material, and of a second layer made of a polymer reinforced with continuous-filament fibers, where the first layer and the second layer have been bonded over a substantial surface area to one another, preferably coherently.

Laminates with a first layer made of a first material, in particular a metal, and of a second layer made of a polymer reinforced with continuous-filament fibers, these having been bonded over a substantial surface area to one another, are used by way of example as replacement for metal components, in order to allow realization of the components with smaller mass for identical strength and/or stiffness.

Weight reduction achieved only through use of thinner sheet metal parts has the disadvantage of resultant reduced stability: because thin metal sheet has low wall thickness, it is borderline in terms of the rigidity required to resist buckling. By way of example, minimum thicknesses required to prevent buckling are from 0.5 to 0.8 mm when an all-steel skin is used and from 0.8 to 1.2 mm when an all-aluminum skin is used. In order to achieve a further reduction of sheet metal thicknesses in regions where there is a risk of buckling, it is therefore advisable to use local reinforcement systems, which by way of example can be realized by bonding the sheet metal to a fiber-reinforced polymer material.

When a sheet metal part is reinforced with a fiber-reinforced polymer material, the thermal expansion difference is disadvantageous. An additional factor in the case of fiber-reinforced polymer materials is that these have anisotropic properties resulting from the orientation of the fibers, and when thermal expansion occurs this causes the expansion of the material along the fiber direction to differ from that perpendicular to the fiber direction. In the known fiber-reinforced plastics comprising fibers oriented in a plurality of directions, the different coefficients of thermal expansion along the fiber direction and perpendicular thereto can, when temperature differences arise, cause deformation phenomena, which differ from the free deformation of an individual layer with only one fiber direction on exposure to thermal stress. In the composite, the bonding between the materials does not generally permit free development of the thermal expansions of said individual layers, and internal thermal stresses are produced. Internal thermal stresses can be present here whenever the usage temperature of the composite differs from its production temperature, at which it is usually stress-free. Internal thermal stresses can in particular be a cause of unacceptably great distortion, depending on the structure of the composite and on exterior storage conditions.

The different thermal expansion of the different materials is particularly problematic in bodywork components of motor vehicles, since these have exposure to high temperatures of up to 200° C. even before the painting process is complete, and temperature differences of up to 120 K can also occur during normal operation. The differences in thermal expansions lead to internal stresses, which can lead to failure of the laminate and/or to distortion, which results in unacceptable deformation phenomena or visible effects on the surface.

DE-A 10 2006 058 601 discloses a bodywork and chassis part which has a metallic base and a reinforcement part made of a fiber-plastics composite. An adhesive secures the fiber-plastics composite on the metallic base. Compensation of different thermal expansions is provided by using an adhesive with low modulus of elasticity which can be applied in a relatively high layer thickness, and thus reacts more flexibly than adhesives having only very low layer thickness.

DE-A 10 2010 014 541 relates to an external cladding part for a shell of a motor vehicle, where the external cladding part is a large-surface-area sheet metal part with, at least to some extent attached to the internal side thereof, a substructure made of a fiber-reinforced plastic. There is only partial bonding here between the substructure and the sheet metal part. There are interruptions in the plastics substructure in order to allow absorption of deformation of the sheet metal part.

DE-A 38 18 478 discloses a composite material made of a metal layer and of a fiber-reinforced polypropylene layer, where the degree of crosslinking of the polypropylene and the content of fibers in the fiber-reinforced polypropylene layer are adjusted in such a way that the thermal expansion corresponds to the thermal expansion of the metal. Because the polypropylene has been crosslinked, the polymer material has the disadvantage of lack of recyclability. Furthermore, polypropylene is in particular not suitable for use in motor vehicle bodywork because polypropylene is not dimensionally stable at the temperatures arising in the painting process. Another disadvantage is that the fiber-reinforced polypropylene layers disclosed in DE-A 38 18 478, with random fiber mats, have comparatively low stiffness.

It is an object of the present invention to provide a laminate which does not have the disadvantages known from the prior art, made of a first layer made of a first material, and of a second layer made of a polymer reinforced with continuous-filament fibers.

The object is achieved via a laminate composed of a first layer made of a first material, and of a second layer made of a polymer reinforced with continuous-filament fibers, where the first layer and the second layer have been bonded over a substantial surface area to one another, preferably coherently, where the continuous-filament fibers in the second layer have been oriented in at least three fiber directions, where the three fiber directions lie within a plane oriented parallel to the first layer, and the fiber content has been adjusted in such a way that the coefficient of thermal expansion of the second layer in essence corresponds to the coefficient of thermal expansion of the first layer.

Because the continuous-filament fibers are arranged in such a way that these have been oriented in at least three fiber directions, it is possible to obtain high stiffness of the second layer in such a way that this can be used for the reinforcement of the first layer, and in particular to achieve reduced mass in comparison with a component made only of the material of the first layer. Surprisingly, it has moreover been found that even when there are only three fiber directions running within a plane parallel to the first layer it is possible to achieve quasi-isotropic properties, in particular for the purposes of the present invention in respect of thermal expansion in the plane within which the fibers lie.

A particular requirement for achieving the quasi-isotropic properties is that the angles between the fibers rotated with respect to one another are in each case identical. In the case of three fiber directions this means that the angle of rotation of each of the fiber directions with respect to the others is 60⁰. Correspondingly, if there are four fiber directions the angle of rotation of each of the fibers with respect to the others is 45°. The number of fiber directions can be selected as desired, but it is preferable to keep the number of fiber directions as small as possible, in particular to use three or four fiber directions, in order to keep the thickness of the second layer low and thus within a range that is technically advisable.

For the purposes of the present invention, continuous-filament fibers are understood to be filaments which are manufactured continuously and are shortened to a finite length during further processing; the length of these is however substantially greater than the length of long fibers. Long-glass-fiber pellets typically comprise fibers with lengths between 5 mm and 25 mm. The length of the continuous-filament fiber can on the one hand be subject to restriction resulting from the dimensions of the component. On the other hand, the length can be subject to restriction resulting from the semifinished product, as is the case when random fiber mats are used (about 5 cm). It is preferable to select the greatest possible length permitted by the component and, respectively, the semifinished product, in such a way that the length of the fibers corresponds in essence to the dimensions of the component and, respectively, the semifinished product.

In order to obtain the quasi-isotropic properties in planes parallel to the first layer, it is preferable that the quantity of fibers in each of the fiber directions differs by less than 5% by volume from the quantity of fibers in the other fiber directions. By virtue of the correspondingly small difference between the fibers in each of the fiber directions, the properties of the polymer reinforced with the continuous-filament fibers are, in the plane within which the fibers lie, in essence identical in each direction. It is further preferable here that the quantity of fibers in each of the fiber directions differs by less than 2% by volume from the quantity of the fibers in the other fiber directions, and in particular that the quantity of fibers in each of the fiber directions differs by less than 1% by volume from the quantity of the fibers in the other fiber directions. It is very particularly preferable that the quantity of fibers in each of the fiber directions is identical.

In order to obtain the quasi-isotropic properties in planes parallel to the first layer, it is preferable that the orientation of the fibers in each of the fiber directions differs by less than 5° from the intended orientation. By virtue of the correspondingly small deviation of the orientation in each of the fiber directions, the properties of the polymer reinforced with the continuous-filament fibers are, in the plane within which the fibers lie, in essence identical in each direction. It is further preferable here that the orientation of the fibers in each of the fiber directions differs by less than 2° from the intended orientation, and in particular that the orientation of the fibers in each of the fiber directions differs by less than 1° from the intended orientation. Very particular preference is given to an orientation of the fibers in each of the fiber directions that achieves the same angle between all three fiber directions.

The total fiber content in the polymer reinforced with continuous-filament fibers depends on the nature of the fibers used and on the material of the first layer. The total fiber content of the polymer reinforced with continuous-filament fibers is preferably in the range from 1 to 70% by volume, in particular from 15 to 65% by volume. The total fiber content is very particularly preferably in the range from 35 to 55% by volume. The total fiber content here is adjusted in such a way that the coefficient of thermal expansion of the polymer reinforced with continuous-filament fibers corresponds to the coefficient of expansion of the material of the first layer. A very general rule here is that the coefficient of thermal expansion decreases as the total fiber content increases.

If a material selected as fiber material is one that cannot itself, at maximal total fiber content, achieve the coefficient of thermal expansion of the material of the first layer, it is possible to make additional use of fibers made of one or more other materials. This is equally possible when the total fiber content is intended not to be more than or less than a certain value. The materials of the fibers here are selected in such a way that these have different coefficients of thermal expansion, thus permitting adjustment of the coefficient of thermal expansion of the material reinforced with continuous-filament fibers.

The various fiber materials can also differ in other properties. By way of example, the modulae of elasticity of the various fiber materials can be different. Differences in other properties of the material reinforced with continuous-filament fibers are thus achieved, alongside differences in the coefficient of thermal expansion.

In order that quasi-isotropic properties are also obtained when various fiber materials are used, it is preferable that, when various fiber materials are used, the fiber content of any fiber material in each of the fiber directions differs by no more than 5% by volume from the fiber content of this fiber material in the other fiber directions. It is further preferable that the content of any fiber material does not differ by more than 2% by volume from the fiber content of this fiber material in the other fiber directions, and it is particularly preferable that the content does not differ by more than 1% by volume. In particular, the fiber content of each fiber material is identical in each of the fiber directions.

In order that quasi-isotropic properties are also obtained when various fiber materials are used, it is preferable that the orientation of the fibers in each of the fiber directions differs by less than 5° from the intended orientation. By virtue of the correspondingly small deviation of the orientation in each of the fiber directions, the properties of the polymer reinforced with the continuous-filament fibers are, in the plane within which the fibers lie, in essence identical in each direction. It is further preferable here that the orientation of the fibers in each of the fiber directions differs by less than 2° from the intended orientation, and in particular that the orientation of the fibers in each of the fiber directions differs by less than 1° from the intended orientation. Very particular preference is given to an orientation of the fibers in each of the fiber directions which achieves the same angle between all three fiber directions.

In order to obtain maximum possible stiffness of the second layer made of the polymer reinforced with continuous-filament fibers, it is preferable that the orientation of the fibers is always in planes parallel to the first layer. It is further preferable to use parallel-oriented fibers. To this end, the fibers comprised in the polymer reinforced with continuous-filament fibers can take the form either of textile or of parallel-oriented continuous-filament fibers. It is particularly preferable that the fibers are parallel-oriented continuous-filament fibers.

If the fibers used take the form of parallel-oriented continuous-filament fibers, it is by way of example possible to use what are known as tapes. The continuous-filament fibers present in these have parallel orientation and have been saturated with polymer material. The term individual layer is also used for these hereinafter.

Since the fibers in a textile have already been orientated in two fiber directions, it is necessary when using a textile to use at least two textile plies rotated with respect to one another. Two textile plies therefore give four fiber directions, and the angle of rotation of the two textile plies with respect to one another should therefore be 45°.

It is possible to produce the second layer by firstly inserting the fibers for the second layer into a mold and then saturating with the polymer material. In this case, the fibers for the second layer must have been oriented in a plurality of fiber directions rotated with respect to one another.

Alternatively it is also possible to construct the second layer from a plurality of individual layers, where the respective individual layers have been manufactured from a polymer reinforced with parallel-arranged continuous-filament fibers, and the individual layers have been rotated with respect to one another in order to obtain the fiber orientations. It is moreover also possible to construct the second layer from a plurality of plies which already comprise fibers in at least three fiber directions. In this case, the plies can have been rotated with respect to one another, but this is not essential.

If the second layer made of the polymer reinforced with continuous-filament fibers has been constructed from a plurality of plies, it is moreover possible that the respective plies have different fiber contents. In this case the only important consideration is that each of the layers has quasi-isotropic properties. The coefficient of thermal expansion of the second layer can then be adjusted via appropriate adjustment of the fiber content of the plies. Different fiber contents of the plies can on the one hand mean that the total fiber content in each ply is different, or alternatively that the plies comprise fibers made of different materials, and the respective fiber contents of the individual fiber materials in the plies are different.

Another possibility, alongside different fiber contents or fiber mixtures in the plies, is provision of only a single fiber material for each ply, where each ply comprises a different fiber material. In this case it is necessary that each ply comprises fibers oriented in at least three fiber directions.

Another possibility, in addition to the plies with a polymer reinforced by continuous-filament fibers, is moreover that the second layer additionally comprises intermediate layers made of a material that is not fiber-reinforced, e.g. a polymer that is not reinforced.

The structure made of individual layers and/or plies results in many parameters which have an effect on the coefficient of thermal expansion, and thus have a direct effect on thermal distortion. Although this circumstance renders the adjustment of coefficient of thermal expansion complex, it also provides a large degree of freedom of action. The coefficient of thermal expansion here can be determined either via suitable experimentation or alternatively via a suitable simulation calculation of the type described by way of example in Tsai, S., Hahn, H. T., “Introduction to Composite Materials”, Technomic Publishing Company, Westport, Conn., 1980. Suitable measurement methods are described by way of example in the Standard ISO 11359-2:1999-10 “Plastics—Thermomechanical Analysis (TMA)—Part 2: Determination of coefficient of linear thermal expansion and glass transition temperature”.

The coefficient of thermal expansion of the fiber-reinforced plastic can by way of example be calculated from the following micromechanical model:

The coefficient of linear thermal expansion longitudinally with respect to the fiber orientation of an individual layer reinforced unidirectionally with continuous-filament fibers is given by:

$${α}_{p} = \frac{{α}_{m} \cdot {E}_{m} \cdot ( 1 - ϕ ) + {α}_{fp} \cdot {E}_{fp} \cdot ϕ}{{E}_{m} \cdot ( 1 - ϕ ) + {E}_{fp} \cdot ϕ} \qquad ( 1 )$$

and perpendicularly with respect to the fiber orientation the value is given by:

$${α}_{q} = {α}_{m} - ( {α}_{m} - {α}_{fq} ) \cdot [ \frac{2 ( {v}_{m}^{3} + {v}_{m}^{2} - {v}_{m} - 1 ) 1 , 1 \cdot ϕ}{1 , 1 \cdot ϕ ( 2 {v}_{m}^{2} + {v}_{m} - 1 ) - ( 1 + {v}_{m} )} - \frac{1 , 1 \cdot ϕ \cdot {v}_{m} \cdot {E}_{fq}}{1 , 1 \cdot ϕ \cdot {E}_{fq} + {E}_{m} \cdot ( 1 - 1 , 1 \cdot ϕ )} ] \qquad ( 2 )$$

where α is the coefficient of linear thermal expansion, E is the modulus of elasticity, φ is the relative fiber content by volume, and ν is the coefficient of transverse contraction, and the indices have the following meanings: p parallel to the fiber direction, q perpendicularly to the fiber direction, f fiber, and m matrix.

For a layer structure that is symmetrical about its center, the effective coefficients of thermal linear expansion are given by

$$[ \begin{matrix}{α}_{x} \\ {α}_{y} \\ {α}_{xy}\end{matrix} ] = {A}_{ij}^{- 1} \cdot [ \begin{matrix}{N}_{x}^{T} ( Δ T = 1 K ) \\ {N}_{y}^{T} ( Δ T = 1 K ) \\ {N}_{xy}^{T} ( Δ T = 1 K )\end{matrix} ] \qquad ( 3 )$$

where the laminar stiffness matrix is

$${A}_{ij} = {\int }_{- h / 2}^{h / 2} {\overline{Q}}_{ij} dz \qquad ( 4 )$$

and the thermal sectional forces are

$$[ \begin{matrix}{N}_{x}^{T} \\ {N}_{y}^{T} \\ {N}_{xy}^{T}\end{matrix} ] = {\int }_{- h / 2}^{h / 2} [ \begin{matrix}{\overline{Q}}_{11} & {\overline{Q}}_{12} & {\overline{Q}}_{16} \\ {\overline{Q}}_{12} & {\overline{Q}}_{22} & {\overline{Q}}_{26} \\ {\overline{Q}}_{16} & {\overline{Q}}_{26} & {\overline{Q}}_{66}\end{matrix} ] \cdot [ \begin{matrix}{α}_{x} \\ {α}_{y} \\ {α}_{xy}\end{matrix} ] Δ Tdz \qquad ( 5 )$$

where Q̅ᵢⱼ are the relative stiffnesses of the individual layers. The indices 1 and 2 relate to the main axis system of the material and therefore represent longitudinal and perpendicular with respect to the fiber orientation. Index 6 represents the shear component within the plane. αₓ, α_{y} and α_{xy} are the coefficients of linear thermal expansion of the individual layer, and are calculated from the tensor transformation of αₚ and α_{q} from the main axis system of the material into the main axis system for the laminate.

In the case of determination by experimentation it is possible to determine the respective coefficient of thermal expansion for different fiber contents, and to present this in the form of a table or in the form of graphs.

The fibers comprised in the polymer reinforced with continuous-filament fibers are preferably selected from glass fibers, carbon fibers, aramid fibers, potassium titanate fibers, mineral fibers, natural fibers, polymer fibers, and mixtures thereof. Particular preference is given here to glass fibers and carbon fibers, and to a mixture of glass fibers and carbon fibers. The contents of the various fibers here are dependent on the material of the first layer, since the ratios of the fibers to one another affect the coefficient of thermal expansion.

The polymer material of the layer reinforced with continuous-filament fibers can by way of example be a thermoset polymer or a thermoplastic polymer. Examples of suitable thermoset polymers are epoxy resins and polyurethane resins. However, it is particularly preferable that the polymer material is a thermoplastic polymer. Polymers suitable here are any thermoplastic polymers, but particular preference is given here to polyamides. Examples of suitable polyamides are PA 6, PA 66, PA 46, PA 6/10, PA 6T, PA 66T, PA 9T and also PA 11 and PA 12.

In particular when the laminate is used as bodywork component, or else in other applications in which the intention is to achieve reduced mass of components that are otherwise metallic, the material of the first layer is a metal. Metals usually used are in particular steel, aluminum, magnesium, and titanium.

Use of a metal as material for the first layer on the one hand complies with the requirements for a class A surface, and on the other hand it is possible to use simple fastening systems that have already been tested to bond individual components to one another. The bonding of the first layer to the second layer increases stiffness at minimal density; in particular use in a motor vehicle improves crash performance, and increased acoustic damping capability is moreover obtained.

The thickness of the first layer is usually in the range from 0.2 to 1.2 mm. The thickness of the first layer is preferably in the range from 0.2 to 0.7 mm, and the thickness of the first layer here is also dependent on the material used: by way of example preference is given to a thickness of from 0.2 to 0.7 mm when an all-steel skin is used, and to a thickness of from 0.5 to 1.0 mm when an all-aluminum skin is used.

The structure of the second layer then results from the material of the first layer and from the polymer material and fiber material used in the second layer: by way of example, the thermal coefficients of expansion in the temperature range from 0 to 100° C. are for steel 11.7·10⁻⁶ 1/K, for aluminum 23.5·10⁻⁶ 1/K, for polyamide from 90·10⁻⁶ 1/K to 100·10⁻⁶ 1/K, for E glass fibers 5.1·10⁻⁶ 1/K parallel to and perpendicular to the fiber direction, and for HT carbon fibers −0.455·10⁻⁶ 1/K parallel to the fiber direction, and 12.5·10⁻⁶ 1/K perpendicular to the fiber direction.

A conventional polymer matrix exhibits very much higher thermal expansion than the fibers, because of the large difference between the coefficients of expansion of fiber and matrix.

In the case of a structure with parallel-oriented (unidirectionally oriented) fibers in three fiber directions, it has been found that the coefficient of thermal expansion obtained in the temperature range from 20 to 80° C. with fiber content about 30% by volume, with use of glass fibers and polyamide 6 as matrix material, corresponds to that of aluminum. Fiber content of about 65% by volume would be necessary in order to obtain the coefficient of thermal expansion of steel. However, this is in the region of limits of manufacturing technology, and can lead to an unstable fiber-composite material.

In contrast to this, when carbon fibers are used in a structure with parallel-oriented (unidirectionally oriented) fibers in three fiber directions in a temperature range from 20 to 80° C. with fiber content about 7% by volume, the coefficient of thermal expansion of aluminum is obtained, and with fiber content about 15% by volume the coefficient of thermal expansion of steel is obtained. However, this fiber content is too low to obtain an adequate stiffness-increasing effect on the metal at an acceptable wall thickness. This type of layer structure would therefore not be appropriate for lightweight construction.

It has therefore been found that the coefficient of thermal expansion of steel cannot be achieved in a useful manner simply by using carbon-fiber-reinforced polymer or glass-fiber-reinforced polymer in the temperature range from 20 to 80° C., and therefore in particular here it is necessary to use a mixture of glass fibers and carbon fibers to reinforce the polymer material. As already described above, this can be achieved either by using plies with carbon fibers and with glass fibers in alternation, or alternatively by mixing carbon fibers and glass fibers in a ply or individual layer. When plies with carbon fibers and with glass fibers are used in alternation for the second layer, the content of the carbon fibers and of the glass fibers in the plies can be varied in that by way of example different fiber contents are used in the plies. However, in a preferred alternative to achieve different fiber contents within the total fiber content, identical fiber contents are to be used in the respective plies, based in each case on the fiber volume and the volume of the matrix material, but to achieve different contents within the total fiber content here the plies and, respectively, individual layers are to be designed so that their thicknesses differ.

Another possibility for use of a fiber-reinforced material with coefficient of thermal expansion smaller than the coefficient of thermal expansion of the material of the first layer is, by way of example for glass fiber content more than 30% by volume in the second layer and aluminum as material for the first layer, to make additional use of unreinforced intermediate layers, for example in the form of unreinforced films which are bonded to the fiber-reinforced material of the second layer.

When a thermoplastic polymer is used as matrix material, the bonding of the plies and individual layers of the second layer is preferably achieved by welding, in that the matrix material is heated and the plies and individual layers and optionally intermediate layers are mutually superposed and subjected to pressure. Alternatively, it is also possible that the plies and individual layers, and optionally intermediate layers are adhesive-bonded to one another.

The bonding of the second layer to the first layer is likewise achieved by way of example by adhesive bonding. This has the advantage that the fiber-reinforced polymer material is first produced and hardened, in such a way that no stresses and no distortion in the laminate arise through shrinkage during the hardening of the polymer material.

However, another possibility, alternative to adhesive bonding, is to bond the laminate by using an adhesion promoter directly in the process for consolidation of the second layer. However, preference is given to adhesive bonding of the first and the second layer. In the case of adhesive bonding it is also possible to use an adhesion promoter additionally to improve adhesion between the layers.

Requirements placed upon the adhesive system in the construction of bodywork are dependent to a decisive extent on whether the intention is to carry out adhesive bonding before or after the painting process. In principle, cold-hardening adhesives have the advantage that they avoid high internal stresses due to high hardening temperatures. However, use of this type of adhesive is advisable only after the painting process. The reason for this is firstly that only heat-hardening systems provide adequate resistance to the temperature arising during cathodic electrodeposition coating (200° C.). Secondly, single-component heat-hardening adhesives are capable of absorbing oil to a certain extent. Adhesives can in principle be broadly classified as structural adhesives, elastic adhesives, and sealing adhesives. This classification derives in essence from the thickness of the adhesive layer and from the elasticity of the adhesive. By way of example, structural adhesives or elastic adhesives can, depending on the required surface quality of the component, be suitable as adhesive for bonding the first layer to the second layer.

A typical heat-curing single-component structural adhesive is Delomonopox 6093 from DELO Industrie Klebstoffe GmbH & Co KGaA, a heat-curing rubber-based single-component elastic adhesive is Teroson RB 5191 GB, and a heat-curing rubber-based single-component high-elasticity underlining adhesive is Teroson RB 3210 H, the two latter adhesives being marketed by Henkel AG & Co. KGaA.

Adhesion promoters can generally be regarded as substances which improve adhesion between the first layer and the adhesive or between the first layer and the second layer. Among the materials that can be used as adhesion promoters a distinction can in principle be made between low-molecular weight and polymeric adhesion promoters. The low-molecular-weight adhesion promoters are often polymerizable molecules having anchor groups which are first anchored on a surface and then are polymerized or copolymerized. In contrast to this, a feature of polymer-based adhesion promoters is that the functional groups that are within the adhesion promoter and that are important for adhesion are already present in a form bonded within macromolecules before the material is applied. Adhesion promoters made of ready-to-use macromolecules can be used inter alia in conjunction with ready-to-use matrix polymers. A typical example is provided by hot-melt adhesives based on copolyamides, obtainable by way of example with trade mark VESTAMELT®. Suitable polymeric adhesion promoters and their properties are also described in the dissertation by Dipl.-Ing. Konrad Burlon, “Blockcopolymere als Haftvermittler für Kunststoff-Metallverbünde” [Block copolymers as adhesion promoters for plastics-metal composites], TU Darmstadt, 2012.

The thickness of the second layer depends on the desired properties of the laminate and on the fiber material used, and also on the fiber content. Usually thicknesses of the second layer are preferably in the range from 0.5 to 5 mm. When the second layer is composed of a plurality of plies and/or individual layers, and/or intermediate layers, the intended meaning here is the total comprising all plies and/or individual layers and/or intermediate layers of which the second layer is composed.

### EXAMPLES

Commercially available tapes with parallel-oriented (unidirectional) continuous-filament fibers were applied to one side of steel sheets with wall thicknesses from 0.5 to 0.63 mm. Tapes comprising glass fibers, and also tapes comprising carbon fibers, were used here. The fiber content by volume of the tapes comprising glass fibers is 40% by volume, and the thickness of these is 0.25 mm. The fiber content by volume of the tapes comprising carbon fibers is 49% by volume, and the thickness of these is 0.16 mm. The tapes comprising glass fibers, and also the tapes comprising carbon fibers, comprise thermoplastic polyamide 6 as matrix material.

Laminates made respectively of steel or aluminum and of fiber-reinforced plastic were produced via screw-connection of a sheet of steel or aluminum to a sheet made of fiber-reinforced plastic, the free length between the screw connections here being 340 mm. The resultant composite was heated to a temperature of 100° C. in an oven, and observed. In particular, the direction of curvature of the composite and the overall extent of the curvature were of interest here. The direction of curvature here indicates which of the two layers has a larger coefficient of thermal expansion. The material with the higher coefficient of thermal expansion is on the convex side here. The extent of the curvature also provides a qualitative impression of the size of the difference between the coefficients of thermal expansion. In order to permit easy recording of curvatures, the respective laminate is placed on to a flat metal profile in the oven. For reasons of comparability, the respective laminate is placed with the layer made of fiber-reinforced plastic on the metal profile.

A laminate with carbon fibers oriented only in one direction was first produced as comparison, and curvature was recorded parallel to the fiber direction and also perpendicularly to the fiber direction. Substantially greater expansion of the fiber-reinforced plastic was found perpendicularly to the fiber direction, whereas parallel to the fiber direction the expansion of the steel sheet was greater.

For production of a sheet made of a fiber-reinforced plastic with coefficient of thermal expansion corresponding to that of the sheet of steel or aluminum, respective plies made of tapes comprising carbon fibers and of tapes comprising glass fibers were produced where the respective tapes, i.e. the individual layers, had been rotated by 60° with respect to one another. This type of ply structure is characterized by way of example by the symbol (60/0/-60). For quasi-isotropic behavior, a ply here always comprises three individual layers made of the same fiber material respectively rotated by 60° with respect to one another, in such a way that the respective glass fibers, and also the carbon fibers, are present in three fiber directions.

In a first experiment, a sheet of thickness 2.46 mm made of fiber-reinforced plastic was produced, using respectively the same number of plies of carbon-fiber-reinforced tapes and glass-fiber-reinforced tapes, in such a way that the layer thickness ratio of layers comprising glass fibers to layers comprising carbon fibers was 0.64. The plies were arranged symmetrically in thickness direction. The thermal expansion of the sheet made of fiber-reinforced plastic here was smaller than that of the steel sheet.

In a second experiment, a sheet of thickness 3.21 mm made of fiber-reinforced plastic was produced, composed of one ply made of tapes comprising carbon fibers, then three plies made of tapes comprising glass fibers, and finally another ply made of tapes comprising carbon fibers. Again in the case of this layer structure, the thermal expansion of the sheet made of fiber-reinforced plastic was smaller than that of the steel sheet.

In a third experiment, a sheet of thickness 3.96 mm was produced from two plies with carbon-fiber-reinforced tapes and four plies made of tapes comprising glass fibers, again arranged symmetrically in thickness direction. As in the previous experiment, the resultant thermal expansion here was also smaller than that of the steel sheet.

In a fourth experiment, a fiber-reinforced plastics structure was produced as in the third experiment, with an additional supplementary intermediate layer made of a polyamide 6 film of thickness 0.1 mm. The structure made respectively of two plies of tapes comprising carbon fibers, four plies of tapes comprising glass fibers, and one intermediate layer of polyamide film gives a thickness of 4.16 mm for the sheet made of fiber-reinforced plastic. The coefficient of thermal expansion of this sheet in the temperature range from 20 to 80° C. was then identical to that of the steel sheet; this was apparent from the fact that neither the steel sheet nor the sheet made of fiber-reinforced plastic exhibited any curvature.

The stacking of the plies and individual layers with different fiber materials and optionally intermediate layers without fiber-reinforcement can therefore give fiber-reinforced plastics with coefficient of thermal expansion corresponding to that of the metal of the first layer, thus permitting production of a laminate in which, even on heating, no stresses arise through different thermal expansion of the first and second layer.

Even in the first to third experiment, the curvature of the steel sheet was so slight that it would have been possible here to realize a dimensionally stable laminate.

In addition to the experiments with a steel sheet, experiments were also carried out with an aluminum sheet.

In a fifth experiment here, a sheet made of a fiber-reinforced plastic which comprised only glass fibers was produced, the thickness of the sheet being 1.5 mm. The sheet was composed of two plies stacked symmetrically on top of one another, respectively comprising mutually superposed tapes in three fiber directions with a respective angle of 60°. The coefficient of thermal expansion of the resultant sheet was lower than that of the aluminum sheet.

In a sixth experiment, a sheet of thickness 2 mm was produced, composed of repeating plies using the following sequence: a ply which comprised, in three fiber directions, mutually superposed tapes with a respective angle of 60° to one another, an intermediate layer made of a polyamide film of thickness 0.5 mm without fibers, and a further ply made of glass-fiber-reinforced tapes. The thermal expansion of this sheet in the temperature range from 20 to 80° C. was the same as that of the aluminum sheet; this was discernible in that neither the aluminum sheet nor the sheet made of fiber-reinforced plastic exhibited any curvature.

Here again it is found that an appropriate layer structure can give a coefficient of thermal expansion corresponding to that of the aluminum sheet.

In addition to the experiments, the respective coefficient of thermal expansion was also calculated in accordance with the above basis for calculation according to equation 1 to 5. It was found here that there was qualitative agreement between the calculated and the measured coefficients of expansion.

1-15. (canceled)

16. A laminate, comprising:
a first layer made of a first material; and
a second layer made of a polymer reinforced with continuous-filament fibers, wherein:
the first layer and the second layer have been bonded over a substantial surface area to one another;
the continuous-filament fibers in the second layer have been oriented in at least three fiber directions, where the three fiber directions lie within a plane oriented parallel to the first layer;
the fiber content has been adjusted in such a way that the coefficient of thermal expansion of the second layer corresponds to the coefficient of thermal expansion of the first layer;
the first material is a metal;
the total fiber content of the polymer reinforced with continuous-filament fibers ranges from 1 to 70% by volume; and
the second layer is constructed from a plurality of individual layers, respectively rotated in relation to one another, made of a fiber-reinforced polymer, or
the second layer comprises a plurality of plies with continuous-filament fibers, where the continuous-filament fibers within a ply are present in a plurality of fiber directions rotated with respect to one another.

17. The laminate according to claim 16, wherein the quantity of fibers in each of the fiber directions differs by less than 5% by volume from the quantity of fibers in the other fiber directions.

18. The laminate according to claim 16, wherein the orientation of the fibers in each of the fiber directions differs by less than 5° from the intended orientation of the fibers.

19. The laminate according to claim 16, wherein the angles between the intended fiber directions are in each case identical.

20. The laminate according claim 16, wherein, when various fiber materials are used, the fiber content of any fiber material in each of the fiber directions differs by no more than 5% by volume from the fiber content of this fiber material in the other fiber directions.

21. The laminate according to claim 16, wherein the fibers comprised in the polymer reinforced with continuous-filament fibers take the form of textile or of parallel-oriented continuous-filament fibers.

22. The laminate according to claim 16, wherein the second layer further comprises an intermediate layer made of a polymer that is not fiber-reinforced.

23. The laminate according to claim 16, wherein the polymer material of the layer reinforced with continuous-filament fibers is selected from the group consisting of a thermoset polymer and a thermoplastic polymer.

24. The laminate according to claim 16, wherein the fibers are selected from the group consisting of glass fibers, carbon fibers, aramid fibers, potassium titanate fibers, mineral fibers, natural fibers, polymer fibers, and mixtures thereof.

25. The laminate according to claim 16, wherein, when a plurality of fiber materials are used, the content of each fiber material in each of the fiber directions is identical.

26. The laminate according to claim 16, wherein the metal is selected from the group consisting of steel, aluminum, magnesium, and titanium.

27. The laminate according to claim 16, wherein the thickness of the first layer ranges from 0.2 to 1.2 mm, the thickness of the second layer ranges from 0.5 to 5 mm, or both.
